(19) United States
(12) Patent Application Publication
(10) Pub. No.: US 2003/0123489 A1
(43) Pub. Date: Jul. 3, 2003

(54) Circuit for generating time division multiplex signal

(75) Inventor: Noriyuki Banno, Yokohama-shi (JP)

Correspondence Address: OLIFF & BERRIDGE, PLC, P.O. BOX 19928, ALEXANDRIA, VA, 22320, US

(73) Assignee: Ando Electric Co., Ltd., Tokyo (JP)

(21) Appl. No.: 10/298,921

(22) Filed: Nov. 19, 2002

(30) Foreign Application Priority Data
Dec. 27, 2001 (JP) 2001-398039

(51) Int. Cl. H04J 3/06

(52) U.S. Cl. 370/503

(57) ABSTRACT

A circuit for generating a time division multiplex signal, that hardly degrades a phase margin of a test pattern which is outputted as the time division multiplex signal. The circuit for generating a time division multiplex signal, has: a signal generator for generating a plurality of parallel signals; a phase synchronous circuit for advancing a phase of a clock signal; a divider for dividing a frequency of an output outputted from the phase synchronous circuit, for every predetermined clock number; and a time division multiplexer for time-division multiplexing the plurality of parallel signals generated by the signal generator, according to the output outputted from the phase synchronous circuit.

### BACKGROUND OF THE INVENTION

1. Field of the Invention

The present invention relates to a circuit for generating a time division multiplex signal, and in particular to a circuit for generating a time division multiplex signal, that does not degrade a phase margin of a test pattern which is outputted.

2. Description of Related Art

Recently, a signal generator generates a test pattern at a higher bit rate, and outputs a large number of test patterns.

In order to increase the bit rate of the test pattern, the signal generator generates signals in parallel, and a multiplexer of the signal generator time-division multiplexes the signals. Thereby, the signal generator generates the high speed test pattern.

Further, in order to output a large number of test patterns, the signal generator comprises a plurality of circuits for generating a time division multiplex signal, which generate test patterns, and synchronizes the circuits with each other.

A structure of a circuit for generating a time division multiplex signal according to an earlier development is shown in FIG. 4.

The circuit for generating a time division multiplex signal shown in FIG. 4 comprises a clock input terminal T1, a divider 10, a signal generator 1, a first delay element 11, a second delay element 12, first to m-time division multiplexers 4 to 6, first to m-retiming circuits 7 to 9, and first to m-test pattern output terminals T2 to Tm.

The divider 10 divides a frequency of a clock inputted to the clock input terminal T1, by “n”, and outputs a divided clock.

The first delay element 11 delays the divided clock for a time Td4, and outputs a delayed divided clock.

The second delay element 12 delays the clock for a time Td5, and outputs a delayed clock.

The signal generator 1 receives the divided clock, and outputs n-parallel test patterns 1 to m, at the same time.

The first to m-time division multiplexers 4 to 6 time-division multiplex the n-parallel test patterns 1 to m by “n”, and output time division multiplex outputs 1 to m, respectively, in synchronism with the delayed divided clock.

The first to m-retiming circuits 7 to 9 retimes the time division multiplex outputs 1 to m, and outputs test patterns 1 to m, respectively, in synchronism with the delayed clock.

The first to m-time division multiplexers 4 to 6 include phase synchronous circuits respectively, in order to synchronize with each other. Therefore, the time division multiplexers 4 to 6 control the phase synchronous circuits so that they operate at the same time, and output the time division multiplex outputs 1 to m so as to synchronize them with each other. The time division multiplex outputs 1 to m outputted from the first to m-time division multiplexers 4 to 6 include much time fluctuation generated in the phase synchronous circuits incorporated in the time division multiplexers 4 to 6.

The first to m-retiming circuits 7 to 9 retimes the time division multiplex outputs 1 to m in synchronous with the delayed clock, and thereby outputs the test patterns including the less time fluctuation.

For example, each of the first to m-time division multiplexers 4 to 6 is a multiplexer consisting of a flip flop and a counter, or the like.

Further, each of the first to m-retiming circuits 7 to 9 is a flip flop or the like.

FIG. 5 shows an example of a timing chart in case “n” is 8 (n=8), in the time division multiplex circuit shown in FIG. 4, according to an earlier development.

In FIG. 5, (b1) is the clock which is inputted to the clock input terminal T1, and (b2) is the divided clock which is generated when the divider 10 divides the frequency of the clock by “n” (n=8 in FIG. 5). (b3) and (b4) are n-parallel test patterns 1 to m which are outputted from the signal generator 1 to the first to m-time division multiplex circuits 4 to 6. (b5) is the delayed divided clock which is generated when the first delay element 11 delays the divided clock for the time Td4 so that the time division multiplexers time-division multiplexes the n-parallel test patterns 1 to m. (b6) is the time division multiplex output which is time-division multiplexed by the time division multiplexer. (b7) is the clock which is supplied to the first to m-retiming circuits 7 to 9 in order to retime the time division multiplex outputs, and generated when the second delay element 12 delays the clock for the time Td5. (b8) is the test pattern which is outputted from the retiming circuit.

The time Td4 for the first delay element 11 coincides with the time from the input of the clock to the output of the n-parallel test patterns 1 to m. Like the time Td4, the time Td5 for the second delay element 12 coincides with the time from the input of the clock to the output of the time division multiplex outputs 1 to m.

Therefore, even if the frequency of the clock to be inputted is changed, the flip flop used in each of the time division multiplexer and the retiming circuit operates so as to keep the constant phase relationship between the data to be inputted and the clock.

FIG. 6 shows an example of a wave form of each of the test patterns 1 to m which are outputted from the time division multiplexers shown in FIG. 4, according to an earlier development. In FIG. 6, a vertical axis indicates a voltage, and a horizontal axis indicates a time.

Along the voltage axis, an upper level is a voltage level showing “1” wherein data are included, and a lower level is a voltage level showing “0” wherein data are not included. The wave form of the test pattern is shown by composing a wave form of a voltage level showing “0”, a wave form of a voltage level showing “1”, a wave form rising from “0” level to “1” level, and a wave form dropping from “1” level to “0” level.

The time division multiplexer shown in FIG. 4, according to an earlier development, requires the first and second delay elements to delay the clock for the predetermined time. However, because the amplitude of the clock is reduced at the same time the clock is delayed by the delay element, there occurs the time fluctuation in the time division multiplexer or the retiming circuit Therefore, because the wide of the wave form of the test pattern which rises from the “0” voltage level to the “1” voltage level, and the wide of the wave form of the test pattern which drops from the “1” voltage level to the “0” voltage level are widened, there is a problem that the phase margin is reduced.

Further, in order to supply the reduction of the amplitude of the clock which is delayed by the delay element, when an amplifier is further provided, a much noise is made in the amplifier. Therefore, like the above-described case, because the wide of the wave form of the test pattern which rises from the “0” voltage level to the “1” voltage level, and the wide of the wave form of the test pattern which drops from the “1” voltage level to the “0” voltage level are widened, there is a problem that the phase margin is reduced.

### SUMMARY OF THE INVENTION

The present invention was developed in view of the above-described problems.

It is an object of the present invention to provide a circuit for generating a time division multiplex signal, that hardly degrades a phase margin of a test pattern which is outputted as the time division multiplex signal.

In order to attain the above-described object, in accordance with a first aspect of the present invention, a circuit for generating a time division multiplex signal, comprises: a signal generator for generating a plurality of parallel signals; a phase synchronous circuit for advancing a phase of a clock signal; a divider for dividing a frequency of an output outputted from the phase synchronous circuit, for every predetermined clock number; and a time division multiplexer for time-division multiplexing the plurality of parallel signals generated by the signal generator, according to the output outputted from the phase synchronous circuit.

According to the circuit, because the circuit comprises the phase synchronous circuit to output an output clock at an earlier time than the clock inputted thereto, it is unnecessary to delay the clock. Consequently, the clock is not reduced, and a phase margin of a test pattern is not degraded. Further, it is unnecessary to further provide an amplifier.

In accordance with a second aspect of the present invention, a circuit for generating a time division multiplex signal, comprises: a signal generator for generating a plurality of parallel signals; a first phase synchronous circuit for advancing a phase of a clock signal for a first time; a divider for dividing a frequency of an output outputted from the first phase synchronous circuit, for every predetermined clock number; a second phase synchronous circuit for advancing a phase of a divided output outputted from the divider, for a second time; a time division multiplexer for time-division multiplexing the plurality of parallel signals generated by the signal generator, according to an output outputted from the second phase synchronous circuit; and a retiming circuit for extracting and retiming an output outputted from the time division multiplexer, according to the clock signal.

According to the circuit, because it is unnecessary to delay the clock to used for retiming, the clock is not reduced, and a phase margin of a test pattern is not degraded.

Preferably, the circuit of the first or second aspect of the present invention, further comprises a plurality of time division multiplexers which are provided in parallel and output a plurality of multiplex outputs.

Accordingly, it is possible to obtain a plurality of time-division multiplex test patterns.

Preferably, in the circuit of the first or second aspect of the present invention, the phase synchronous circuit, or at least one of the first phase synchronous circuit and the second phase synchronous circuit comprises a PLL circuit.

Preferably, in the circuit of the second aspect of the present invention, the retiming circuit comprises a flip flop.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a block diagram showing a structure of a circuit for generating a time division multiplex signal according to an embodiment of the present invention;

FIG. 2 is an exemplary timing chart according to an embodiment shown in FIG. 1;

FIG. 3 is a wave form chart of a test pattern according to an embodiment shown in FIG. 1;

FIG. 4 is a block diagram showing a structure of an embodiment of a circuit for generating a time division multiplex signal according to an earlier development;

FIG. 5 is en exemplary timing chart according to an earlier development shown in FIG. 4; and

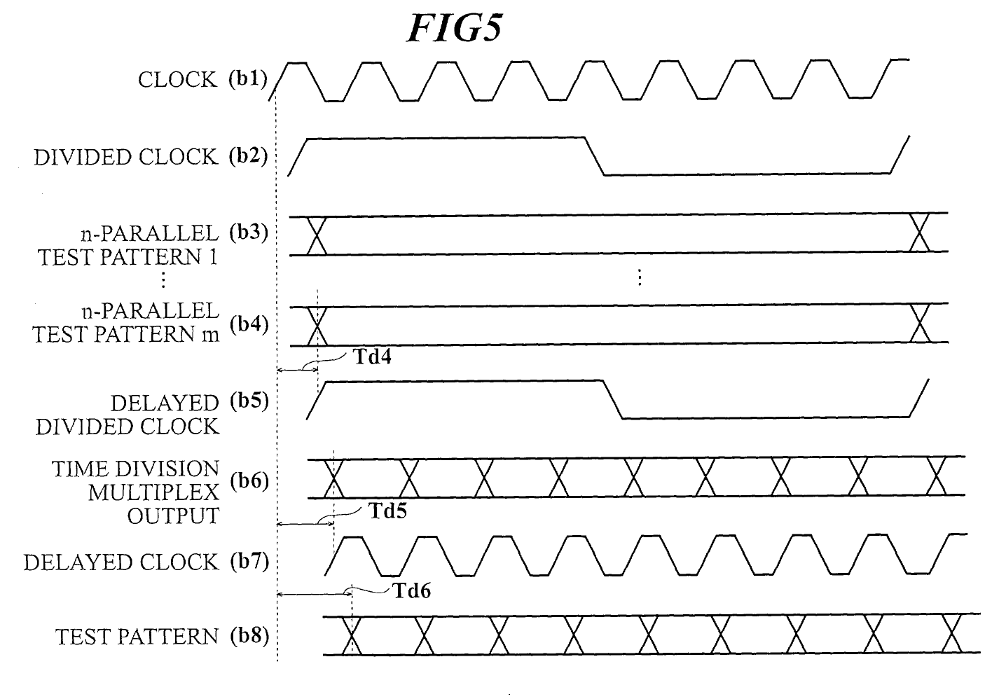

FIG. 6 is a wave form chart of a test pattern according to an earlier development shown in FIG. 4.

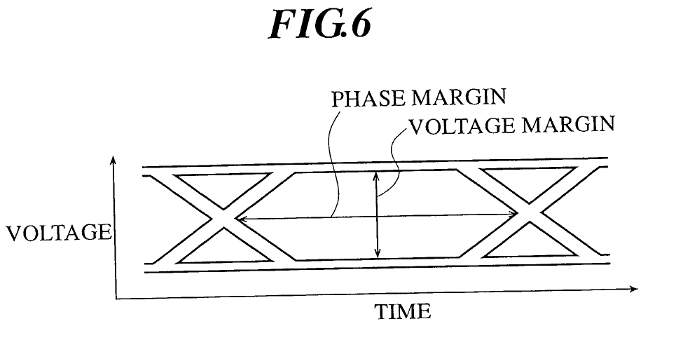

### PREFERRED EMBODIMENTS OF THE INVENTION

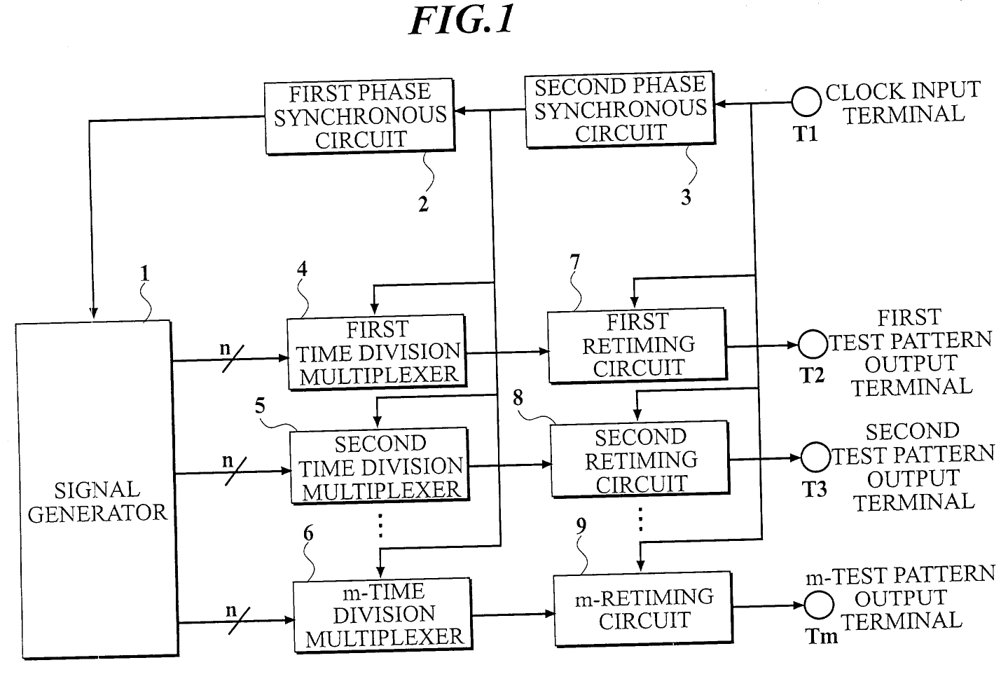

Hereinafter, a preferred embodiment of the present invention will be explained with reference to FIGS. 1 to 3, in detail.

FIG. 1 is a block diagram showing a circuit for generating a time division multiplex signal according to an embodiment of the present invention.

The circuit for generating a time division multiplex signal shown in FIG. 1, comprises a clock input terminal T1, a first phase synchronous circuit 2, a second phase synchronous circuit 3, a signal generator 1, first to m-time division multiplexers 4 to 6, first to m-retiming circuits 7 to 9, and first to m-test pattern output terminals T2 to Tm.

The second phase synchronous circuit 3 comprises a divider.

When the second phase synchronous circuit 3 shown in FIG. 1 receives the clock, the second phase synchronous circuit 3 outputs the divided clock 2 which is advanced for the time Td2 from the input of the clock. Further, when the first phase synchronous circuit 2 receives the divided clock 2, the first phase synchronous circuit 2 outputs the divided clock 1 which is advanced for the time Td1 from the input of the clock.

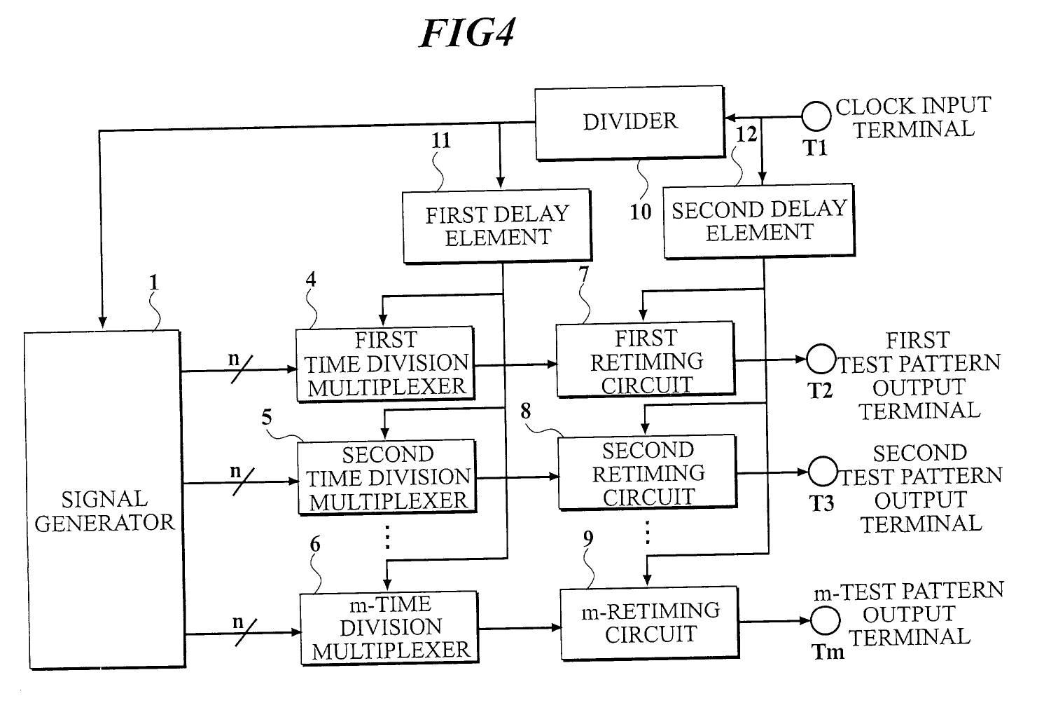

The elements other than the first and second phase synchronous circuits 2 and 3 are the same as those shown in FIG. 4.

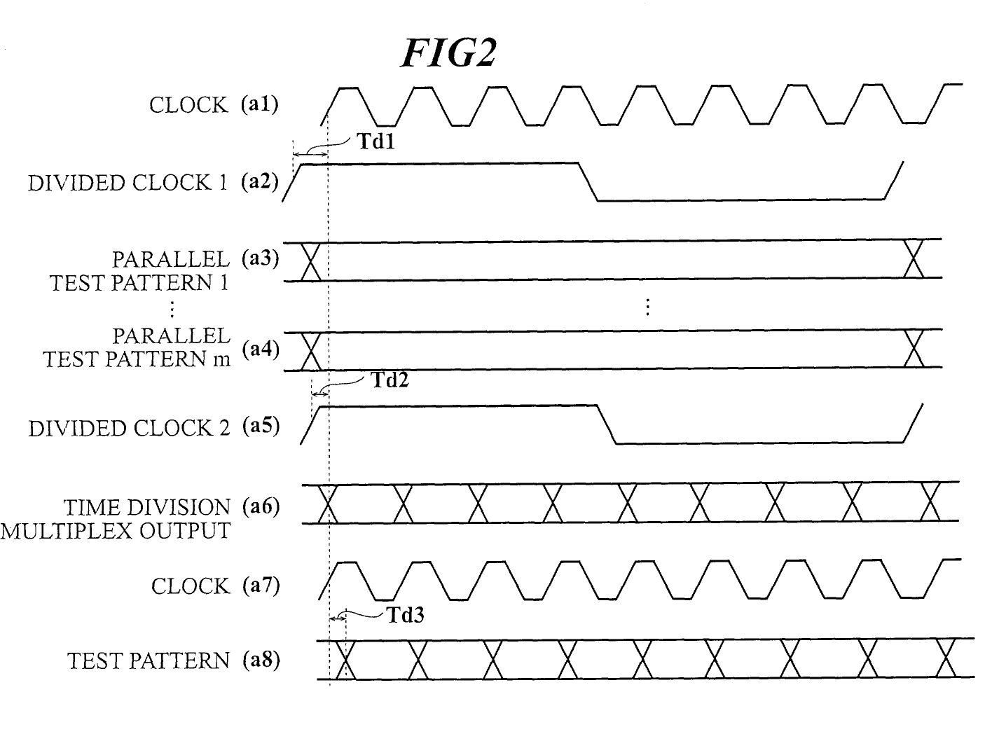

Next, the operation of the circuit for generating a time division multiplex signal shown in FIG. 1 will be explained with reference to a timing chart shown in FIG. 2.

The first phase synchronous circuit 2 advances the divided clock 2 (a5) for the time Td1 from the input of the clock (a1), and outputs the divided clock 1 (a2). Therefore, the signal generator 1 can output the n-parallel test patterns (a3) and (a4) earlier.

Like the first phase synchronous circuit 2, the second phase synchronous circuit 3 advances the clock (a1) for the time Td2 from the input of the clock (a1), and outputs the divided clock 2 (a5). Therefore, the first to m-time division multiplexers 4 to 6 can output the time division multiplex signals (a6) earlier.

Accordingly, it is unnecessary to delay the clock (a7) to be supplied to each of the time division multiplexers 4 to 6, and the retiming circuits 7 to 9. Further, because the clock is not passed through the phase synchronous circuit, the time fluctuation is not generated.

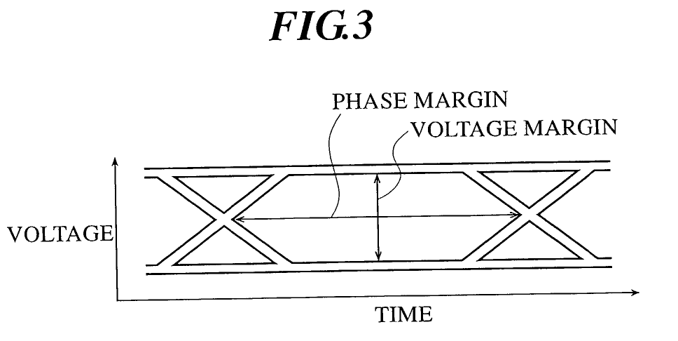

FIG. 3 is a wave form chart showing an example of the test patterns 1 to m which are outputted from the time division multiplexers of the present invention, shown in FIG. 1.

As shown in FIG. 3, because the wide of the wave form of the test pattern which rises from the “0” voltage level to the “1” voltage level, and the wide of the wave form of the test pattern which drops from the “1” voltage level to the “0” voltage level are not widened, the phase margin is not degraded.

Herein, the structure according to an embodiment shown in FIG. 1, may not comprise the retiming circuits 7 to 9 and the second phase synchronous circuit 3. Further, although it has been explained that there are the first to m-test pattern output terminals, there may be one test pattern output terminal.

Although the present invention has been explained according to the above-described embodiment, it should also be understood that the present invention is not limited to the embodiment and various chanted and modifications may be made to the invention without departing from the gist thereof.

According to the present invention, the following effects will be indicated.

As described above, because the circuit comprises the phase synchronous circuit to output the output clock at the earlier time than the clock inputted thereto, it is unnecessary to delay the clock. Consequently, the clock is not reduced, and the phase margin of the test pattern is not degraded. Further, it is unnecessary to further provide an amplifier.

Further, because it is unnecessary to delay the clock to used for retiming, the clock is not reduced, and the phase margin of the test pattern is not degraded.

Furthermore, it is possible to obtain a plurality of time-division multiplex test patterns.

The entire disclosure of Japanese Patent Application No. Tokugan 2001-398039 filed on Dec. 27, 2001 including specification, claims, drawings and summary are incorporated herein by reference in its entirety.

What is claimed is:

1. A circuit for generating a time division multiplex signal, comprising:
a signal generator for generating a plurality of parallel signals;
a phase synchronous circuit for advancing a phase of a clock signal;
a divider for dividing a frequency of an output outputted from the phase synchronous circuit, for every predetermined clock number; and
a time division multiplexer for time-division multiplexing the plurality of parallel signals generated by the signal generator, according to the output outputted from the phase synchronous circuit.

2. A circuit for generating a time division multiplex signal, comprising:
a signal generator for generating a plurality of parallel signals;
a first phase synchronous circuit for advancing a phase of a clock signal for a first time;
a divider for dividing a frequency of an output outputted from the first phase synchronous circuit, for every predetermined clock number;
a second phase synchronous circuit for advancing a phase of a divided output outputted from the divider, for a second time;
a time division multiplexer for time-division multiplexing the plurality of parallel signals generated by the signal generator, according to an output outputted from the second phase synchronous circuit; and
a retiming circuit for extracting and retiming an output outputted from the time division multiplexer, according to the clock signal.

3. The circuit as claimed in any one of claims 1 and 2, further comprising a plurality of time division multiplexers which are provided in parallel and output a plurality of multiplex outputs.

4. The circuit as claimed in claim 1, wherein the phase synchronous circuit comprises a PLL circuit.

5. The circuit as claimed in claim 2, wherein at least one of the first phase synchronous circuit and the second phase synchronous circuit comprises a PLL circuit.

6. The circuit as claimed in claim 2, wherein the retiming circuit comprises a flip flop.

7. A circuit for generating a time division multiplex signal, comprising:
a signal generating means for generating a plurality of parallel signals;
a phase synchronizing means for advancing a phase of a clock signal;
a dividing means for dividing a frequency of an output outputted from the phase synchronous circuit, for every predetermined clock number; and
a time division multiplexing means for time-division multiplexing the plurality of parallel signals generated by the signal generator, according to the output outputted from the phase synchronous circuit.

8. A circuit for generating a time division multiplex signal, comprising:
a signal generating means for generating a plurality of parallel signals;
a first phase synchronizing means for advancing a phase of a clock signal for a first time;
a dividing means for dividing a frequency of an output outputted from the first phase synchronous circuit, for every predetermined clock number;
a second phase synchronizing means for advancing a phase of a divided output outputted from the divider, for a second time;
a time division multiplexing means for time-division multiplexing the plurality of parallel signals generated by the signal generator, according to an output outputted from the second phase synchronous circuit; and
a retiming means for extracting and retiming an output outputted from the time division multiplexer, according to the clock signal.
